(19) United States
(12) Patent Application Publication
(10) Pub. No.: US 2002/0105673 A1
(43) Pub. Date: Aug. 8, 2002

(54) Printing apparatus and printing method

(76) Inventor: Hiroyasu Kurashina, Matsumoto-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/035,044

(22) Filed: Dec. 27, 2001

(30) Foreign Application Priority Data
Jan. 12, 2001 (JP) 2001-004974

(51) Int. Cl. G06F 15/00; B41J 1/00

(52) U.S. Cl. 358/1.15

(57) ABSTRACT

There is provided a printing apparatus and method which is capable of easily printing question data and answer data in a predetermine format enabling relevancy therebetween to be visually recognized. Stored data including question data and answer data which are stored in a manner correlated with each other are read out. The question data and the answer data are printed on a print medium, based on the stored data read out, in a predetermined format enabling relevancy between the question data and the answer data to be visually recognized.

### BACKGROUND OF THE INVENTION

1. Field of the Invention

This invention relates to a printing apparatus and method which is capable of printing question data and answer data, based on stored data including the question data and the answer data which are stored in a manner correlated with each other, in a predetermined format enabling visual recognition of the relevancy therebetween.

2. Prior Art

Conventionally, tape printing apparatuses are known which print characters having desired sizes on a print medium and form labels from the printed portion(s) of the print medium. These tape printing apparatuses are widely used since they are capable of forming various kinds of labels by changing the format of characters and decoratively modifying them and the labels thus formed thereby are attractive in appearance.

Now, recently, there have been proposed electronic apparatuses storing a large amount of character-based information, such as “electronic dictionaries” which enable search of English words and Kanji characters, and “electronic learning machines” for use as learning tools. For example, in the case of an electronic learning machine as shown in FIG. 15, a question is displayed on the display of the machine (FIG. 16A), and the user inputs an answer, which he thinks is correct. If the answer is correct, the machine displays a message notifying that the answer is correct (FIG. 16B), whereas if the answer is wrong, the same displays a message that the answer is wrong, and a correct answer (FIG. 16C). Then, when a predetermined number of questions are answered, results of learning including a correct answer ratio or a test score are displayed (FIG. 16D).

As described above, the electronic learning machine proceeds with learning while allowing the user to view questions and confirm results of answers displayed on the screen. However, the results of learning are only temporarily displayed and cannot be stored, and hence the results cannot be made use of thereafter. For example, even if only one question out of a total of ten questions is wrong, to repeat the learning, the user has to answer all the ten questions again, which is very inefficient in learning.

A possible solution to this is to prepare a wordbook or word cards. However, it is very troublesome to manually copy the questions and answers displayed on the screen into a notebook or cards. Further, to make the notebook or cards attractive in appearance, even if labels that can be affixed to a wordbook or cards are made by using the above-mentioned tape printing apparatus, it is necessary to perform configurations concerning the format and the direction of printing of the print medium, etc. and hence the printing operation is even more troublesome than the manual copying operation.

### SUMMARY OF THE INVENTION

It is an object of the invention to provide a printing apparatus and method which is capable of easily printing question data and answer data in a predetermined format that enables visual recognition of relevancy therebetween, without performing troublesome operations of configurations.

To attain the above object, according to a first aspect of the invention, there is provided a printing apparatus comprising:

reading means for reading out stored data including question data and answer data corresponding thereto which are stored in a manner correlated with each other; and

printing means for printing the question data and the answer data on a print medium, based on the stored data read out by the reading means, in a predetermined format enabling visual recognition of relevancy between the question data and the answer data.

To attain the above object, according to a second aspect of the invention, there is provided a printing method comprising the steps of:

reading out stored data including question data and answer data corresponding thereto which are stored in a manner correlated with each other; and

printing the question data and the answer data on a print medium, based on the stored data read out, in a predetermined format enabling visual recognition of relevancy between the question data and the answer data.

According to the printing apparatus and method, based on the stored data read out, the question data and the answer data can be printed on a print medium, in a predetermined format enabling visual recognition of relevancy between the question data and the answer data. That is, the data having the relevancy of question-answer can be printed in such an effective format as will make it easy to recognize the relevancy.

It should be noted that the terms “question data” and “answer data corresponding thereto” are intended to mean two things or matters which have a predetermined relationship or relevancy therebetween, including “quiz questions and respective answers corresponding thereto”, “English words and respective meanings thereof”, “events in history and respective years in which the events occurred”.

Preferably, the printing apparatus further includes print data-forming means for forming print data composed of at least one item of the question data and at least one item of the answer data corresponding thereto, respectively, based on the stored data read out by the reading means, and the printing means includes means for printing the question data and the answer data based on the print data formed by the print data-forming means.

Preferably, the printing method further includes the step of forming print data composed of at least one item of the question data and at least one item of the answer data corresponding thereto, respectively, based on the stored data read out, and the step of printing includes printing the question data and the answer data based on the print data formed in the step of forming print data.

According to these preferred embodiments, based on the stored data read out, it is possible to form print data composed of at least one item of the question data and at least one item of the answer data corresponding thereto, respectively, and print the question data and the answer data based on the print data formed in the step of forming print data. That is, by preparing the print data adapted to a predetermined format in advance, it is possible to carry out printing, upon reception of an instruction for printing, without requiring special processing of the print data.

More preferably, the print data-forming means includes means for forming the print data based on designated question data which is arbitrarily selected from the at least one item of the question data and answer data corresponding to the designated question data.

More preferably, the step of forming print data includes forming the print data based on designated question data which is arbitrarily selected from the at least one item of the question data and answer data corresponding to the designated question data.

According to the preferred embodiments, it is possible to form the print data based on designated question data which is arbitrarily selected from the at least one item of the question data and answer data corresponding to the designated question data. That is, it is possible to designate question data and answer data corresponding thereto, in a manner satisfying the user's needs.

More preferably, the print data-forming means includes means for forming the print data based on extracted question data which is extracted from the at least one item of the question data according to a predetermined rule, and answer data corresponding to the designated question data.

More preferably, the step of forming print data includes forming the print data based on extracted question data which is extracted from the at least one item of the question data according to a predetermined rule, and answer data corresponding to the designated question data.

According to the preferred embodiments, it is possible to form the print data based on extracted question data which is extracted from the at least one item of the question data according to a predetermined rule, and answer data corresponding to the designated question data. That is, it is possible to save the user from having to designate question data to be printed and answer data corresponding thereto.

It should be noted that “predetermined rule” includes “rule based on kinds of question data”, “ruled based on kinds of answer data”, “rule based on relationship between the question data and the answer data”, and “rule based on kinds and presence/absence of discrimination data attached to question data and/or answer data”.

More preferably, the print data-forming means includes means for forming the print data by replacing part or all of at least one of the question data and the answer data corresponding to the question data by blank data.

More preferably, the step of forming print data includes forming the print data by replacing part or all of at least one of the question data and the answer data corresponding to the question data by blank data.

According to the preferred embodiments, it is possible to print the print data formed by replacing part or all of at least one of the question data and the answer data corresponding to the question data by blank data. This makes it possible to diversify the format of questions and answers, by forming part of each item of question data as a blank for use as a question, and characters and symbols to be entered in the blank as contents of a corresponding item of answer data.

Preferably, the printing apparatus includes display means for displaying the question data and the answer data, in a state in which the relevancy between the question data and the answer data corresponding thereto can be visually recognized.

According to this preferred embodiment, it is possible to display the question data and the answer data, in a state in which the relevancy between the question data and the answer data can be visually recognized. That is, the data to be printed and format thereof can be checked before printing.

Preferably, the display means includes means for displaying the question data and the answer data in at least one of a state in which the question data and the answer data are displayed separately and a state in which the question data and the answer data are displayed simultaneously.

According to this preferred embodiment, it is possible to display the question data and the answer data separately and/or simultaneously. That is, it is possible to display question data and then switch the display screen to answer data, or display question data and answer data side by side.

Preferably, the printing apparatus further includes cutting means for cutting the print medium to a desired length, and the cutting means includes means for cutting the print medium such that a question portion on which printing is carried out based on the question data and an answer portion on which printing is carried out based on answer data corresponding to the question data come apart.

According to this preferred embodiment, it is possible to cut off the print medium such that the question portion and the answer portion are separate from each other. That is, the question portion and the answer portion can be made use of as separate portions.

Preferably, the printing apparatus further includes cutting means for cutting the print medium to a desired length, and the cutting means includes means for cutting the print medium such that a question portion on which printing is carried out based on the question data and an answer portion on which printing is carried out based on answer data corresponding to the question data are in a state remaining connected to each other.

According to this preferred embodiment, it is possible to cut the print medium into strips such that respective strips of a question portion and a corresponding answer portion are cut in a state remaining connected to each other. That is, a question portion and a corresponding answer portion are printed and cut as a combination or in a unit, and hence there is no confusion among printed question data and printed answer data.

Preferably, the printing apparatus further includes input means capable of inputting at least one of the question data and the answer data.

According to this preferred embodiment, it is possible to input question data and/or answer data. That is, it is possible to form original question data and/or answer data Preferably, the printing apparatus further includes storage means for storing the stored data, and the reading means includes means for reading out the stored data stored in the storage means.

According to this preferred embodiment, the printing apparatus includes storage means for storing the stored data, and hence it is possible to print question data and/or print data without the data being inputted from outside.

Preferably, the printing apparatus further includes external storage device-connecting means for connecting an external storage device storing the stored data to the printing apparatus, and the reading means includes means for reading out the stored data stored in the external storage device via the external storage device-connecting means.

According to this preferred embodiment, it is possible to read out the stored data from the external storage device, and therefore, it is possible to print a wide variety of question data and/or answer data.

Preferably, the printing apparatus further includes storage medium-mounting means for mounting a storage medium storing the stored data, and the reading means includes means for reading out the stored data from the storage medium via the storage medium-mounting means.

According to this preferred embodiment, it is possible to read out the stored data from a storage medium, and hence it is possible to print a wide variety of question data and/or answer data without connecting the printing apparatus to the external storage device.

Preferably, the print medium comprises an image-receiving layer serving as a printing surface, an adhesive layer formed on a reverse side of the image-receiving layer, and a peel layer formed on a side of the adhesive layer opposite to the image-receiving layer, the print medium being affixable to an object article by peeling the image-receiving layer and the adhesive layer from the peel layer.

According to this preferred embodiment, since the print medium comprises an image-receiving layer serving as a printing surface, an adhesive layer formed on a reverse side of the image-receiving layer, and a peel layer formed on a side of the adhesive layer opposite to the image-receiving layer, and hence only by peeling the image-receiving layer and the adhesive layer from the peel layer, the formed print (image-receiving layer) can be affixed to an object article.

Preferably, the print medium is a tape-shaped member.

According to this preferred embodiment, the print medium is a tape-shaped member, and hence the present apparatus can be applied to a tape printing apparatus, which is convenient in forming labels and the like. Further, by storing a roll of the print medium in the printing apparatus, the apparatus can be simplified in construction.

Preferably, the stored data includes question data and answer data having relevancy between a word of a foreign language and a corresponding word of a user's mother tongue.

According to this preferred embodiment, it is possible to print a word of a foreign language and a corresponding word of a user's mother tongue in a format enabling visual recognition of the relevancy therebetween.

Preferably, the stored data includes question data and answer data having relevancy between a word of a language and phonetic symbols corresponding thereto.

According to this preferred embodiment, it is possible to print a word of a language and phonetic symbols corresponding thereto in a format enabling visual recognition of the relevancy therebetween.

Preferably, the stored data includes question data and answer data having relevancy between a name of a provision of a law and contents of the provision.

According to this preferred embodiment, it is possible to print a name of a provision of a law and contents of the provision in a format enabling visual recognition of relevancy therebetween. It should be noted here that the term “provision of a law” is used to mean an itemized section of text of a law, such as one in an act, a treaty, a regulation, etc, usually referred to by using a number assigned thereto.

Preferably, the stored data includes question data and answer data having relevancy between an event in history of a year in which the event occurred.

According to this preferred embodiment, it is possible to print an event in history and a year in which the event occurred in a format enabling visual recognition of the relevancy therebetween.

Preferably, the stored data includes at least one of question data represented in an image or pattern and answer data represented in an image or pattern.

According to this preferred embodiment, it is possible to express question data and/or answer data by an image or pattern, and print them.

The above and other objects, features and advantages of the invention will become more apparent from the following detailed description taken in conjunction with the accompanying drawings.

### BRIEF DESCRIPTION OF THE DRAWINGS

FIG. 1 is a perspective view of the appearance of a tape printing apparatus to which is applied a printing apparatus and method according to an embodiment of the present invention;

FIG. 2 is a perspective view showing the FIG. 1 tape printing apparatus with a lid thereof being open;

FIG. 3 is a block diagram schematically showing a control system of the FIG. 1 tape printing apparatus;

FIG. 4 is a view showing the FIG. 1 tape printing apparatus and an electronic learning machine in a state connected to each other;

FIG. 5 is an explanatory view illustrating an example of a process of inputting and registration of external data, including images displayed on a display screen;

FIG. 6 is a continuation of FIG. 5 explanatory view;

FIG. 7 is a continuation of FIG. 6 explanatory view;

FIG. 8 is an explanatory view illustrating an example of a process of printing, including images displayed on the display screen;

FIG. 9 is an explanatory view illustrating an example of a process of entry and registration of data by a keyboard, including images displayed on the display screen;

FIG. 10 is a continuation of FIG. 9 explanatory view;

FIGS. 11A to 11C are views showing an example of results of the operation by the process in FIG. 8;

FIGS. 12A to 12C are views showing another example of the results different from those of FIGS. 11A to 11C;

FIGS. 13A to 13D are views showing still another example of the results;

FIGS. 14A to 14C are views showing still another example of the results;

FIG. 15 is a view showing an electronic learning machine; and

FIGS. 16A to 16D are views showing examples of images displayed on the FIG. 15 electronic learning machine.

### DETAILED DESCRIPTION OF PREFERRRED EMBODIMENT

The invention will now be described in detail with reference to the drawings showing an embodiment thereof. In the embodiment, a printing apparatus and method according to the invention is applied to a tape printing apparatus.

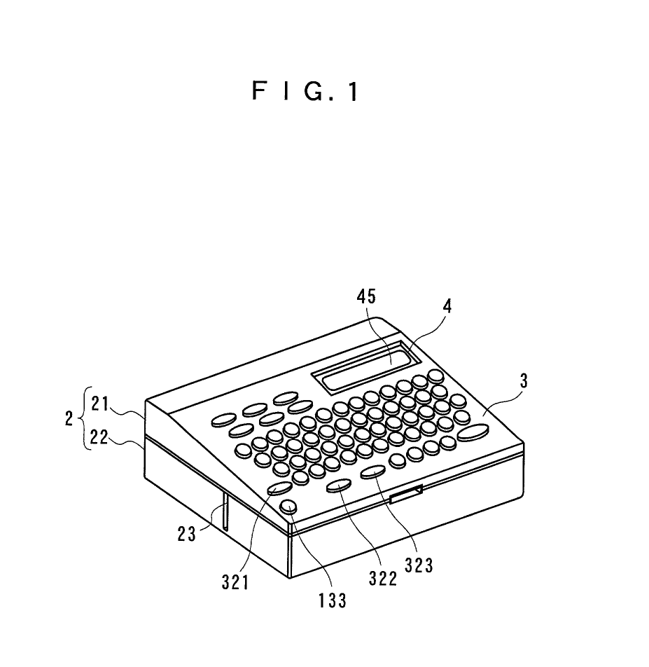

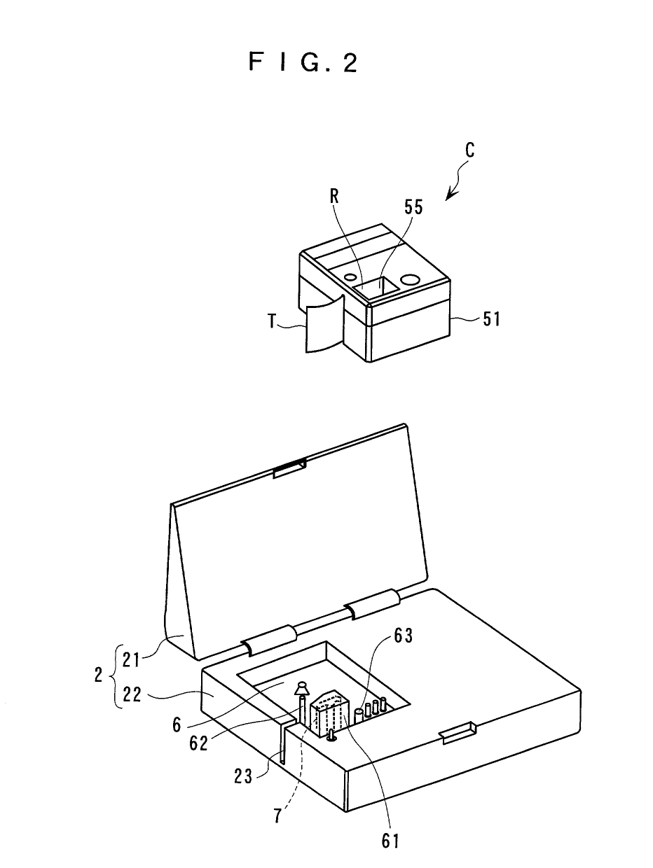

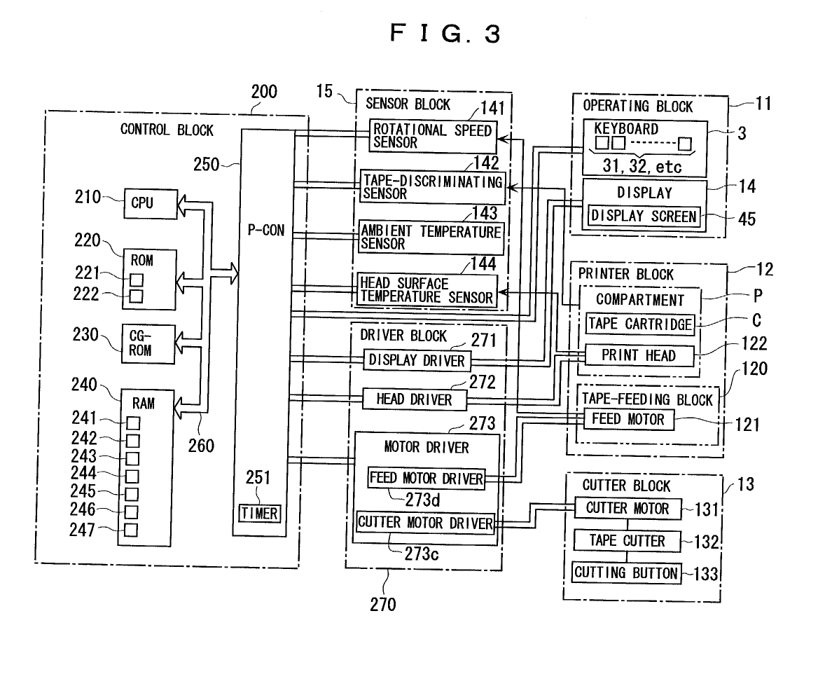

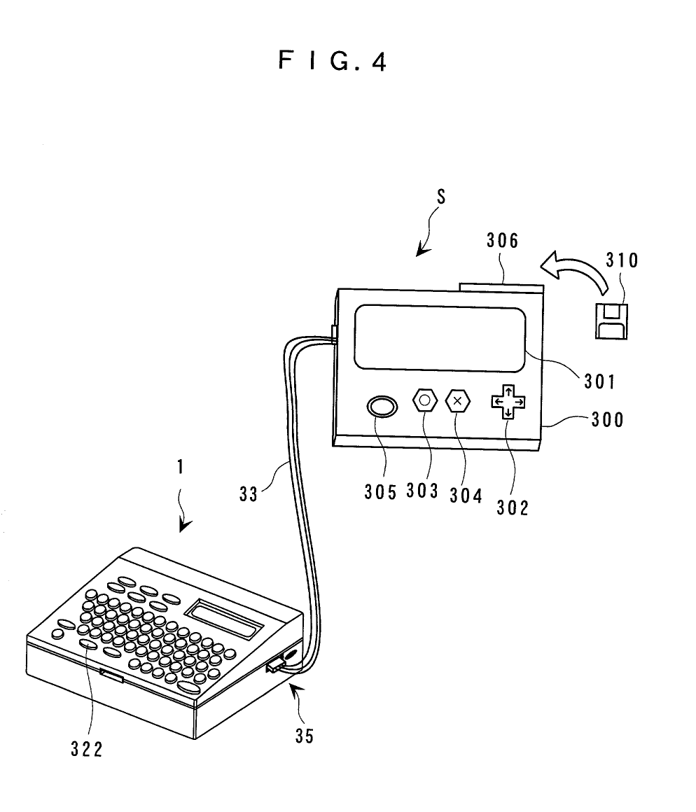

FIG. 1 is a perspective view of the appearance of the whole tape printing apparatus according to the present embodiment, and FIG. 2 is a perspective view of the FIG. 1 tape printing apparatus with its lid being open and a tape cartridge being removed therefrom. FIG. 3 is a block diagram schematically showing a control system of the FIG. 1 tape printing apparatus. As shown in FIGS. 1 and 2, the tape printing apparatus 1 includes a casing 2 which is divided into an upper casing (lid) 21 and a lower casing 22 and forms an outer shell of the apparatus 1. The upper casing 21 has a keyboard 3 and a display arranged therein, and the lower casing 22 has various mechanisms, including a compartment, arranged therein. At a rear portion of a right-hand side of the lower casing 22, there is formed a connector 35 for communicative connection to an external apparatus (see FIG. 4).

Further, as shown in FIG. 3, the tape printing apparatus 1 is basically comprised of an operating block 11 having the keyboard 3 and the display 4 for interfacing with the user, a printer block 12 having a print head (thermal head) 7 and a tape feeder block 120 for printing on a printing tape(hereinafter simply referred to as “the tape”) T unwound from a tape cartridge C mounted in the compartment 6, a cutter block 13 for cutting off a printed portion of the tape T, a sensor block 14 having various sensors for carrying out various detecting operations, a driving block 270 having drivers for driving circuits of devices of the apparatus 1, and a control block 200 for controlling operations of blocks and devices of the apparatus 1 including the above-mentioned sensors and drivers. To implement the above construction, the casing 2 accommodates not only the above-mentioned blocks including the printer block 12, the cutter block 13, and the sensor block 14, but also a circuit board, not shown. On the circuit board are mounted a power supply unit, the circuits of the driving block 270 and the control block 200, etc. The power supply unit is connected to a connector port for connecting an AC adapter thereto, and batteries, such as nicad batteries, which can be removably mounted within the casing 2 from outside.

In the tape printing apparatus 1, after mounting the tape cartridge C in the compartment 6, the user enters printing information, such as desired characters (letters, numerals, symbols, simple figures, etc.) via the keyboard 3, while confirming or viewing the results of the entry or edit of the printing information on the display 4. Thereafter, when the user instructs the apparatus 1 to perform a printing operation via the keyboard 3, the tape feeder block 120 unwinds the tape T from the tape cartridge C, and the print head 7 prints on the tape T. The printed portion of the tape T is delivered from a tape exit 23 as the printing proceeds. When the printing is completed as desired, the tape feeder block 120 further advances the tape T until an end of a tape length (the length of a label to be formed) including the length of margins comes to a cutting position, and then stops the feeding of the tape.

As shown in FIGS. 2 and 3, the printer block 12 has the compartment 6 for mounting the tape cartridge C therein. The tape cartridge C can be mounted in or removed from the compartment 6 when the lid 21 is open. The tape cartridge C has a cartridge casing 51 holding a tape T having a predetermined width (within a range of approximately 4.5 to 48 mm) and an ink ribbon R. The tape cartridge C is formed with a through hole 55 for receiving therein a head unit 61 arranged in the compartment 6. Further, the tape cartridge C has a plurality of small holes formed in the bottom thereof for discrimination of the type of the tape T contained therein from the other types of the tape T having different widths, which are contained in other types of tape cartridges C. The compartment 6 has a tape-discriminating sensor 142 comprised of micro-switches or the like, for detecting the above holes to thereby determine the type of the tape T set for use.

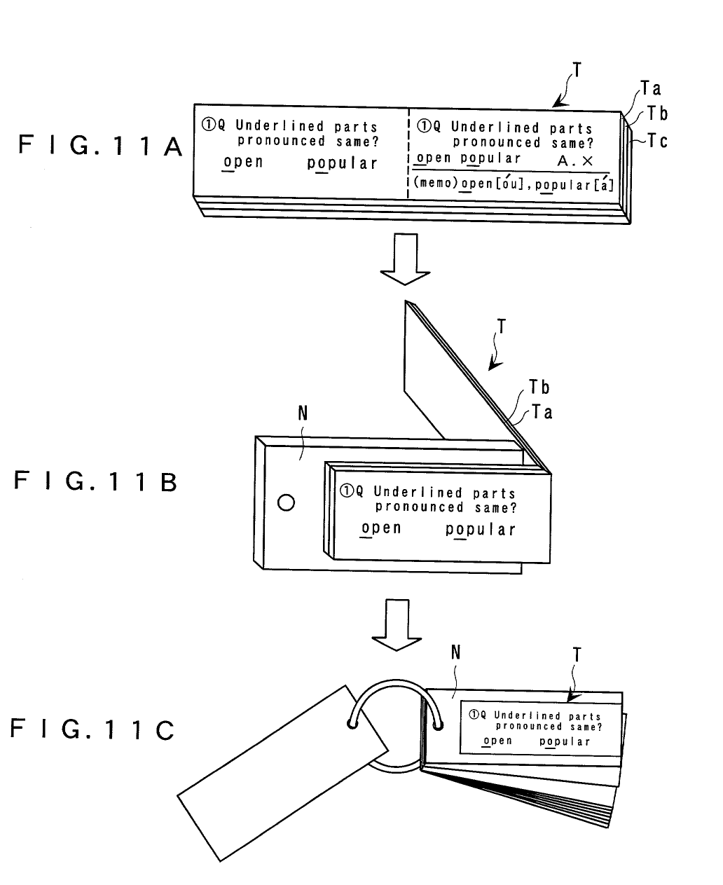

The tape T is comprised of an image-receiving layer Ta which serves as a printing surface, an adhesive layer Tb formed on the reverse side thereof, and a peel layer Tc formed on a side of the adhesive layer Tb opposite to the image-receiving layer Ta (see FIGS. 11A and 11B). The tape T and the ink ribbon R are fed or run such that they pass by the through hole 55, in a state overlaid upon each other, and the tape T alone is delivered out of the tape cartridge C, but the ink ribbon R is taken up into a roll within the tape cartridge C. The printed portion of the tape T delivered from the tape exit 22 has its peel layer Tc peeled off, and then it is affixed to an object article. It should be noted that a tape T without the peel layer Tc may be also used in the tape printing apparatus 1.

The head unit 61 contains the print head 7 implemented by a thermal head. The print head 7 is brought into contact with the reverse side of the ink ribbon R exposed to the through hole 55 of the tape cartridge C when the tape cartridge C is mounted in the compartment 6 with the print head 7 fitted in the through hole 55. Then, by driving the print head 7 while heating the same, desired letters and the like are printed on the surface of the tape T. Further, in the compartment 6, there are arranged an ambient temperature sensor 143, such as a thermistor, for detecting the ambient temperature (temperature of the environment), and supplying a signal indicative of the detected ambient temperature to the control block 200.

Further, the casing 2 (lower casing 22) has a left side portion thereof formed with the tape exit 23 for communication between the compartment 6 and the outside of the apparatus. Opposed to the tape exit 22, there is arranged a tape cutter 132 for cutting off a delivered or dispensed portion of the tape T. Further, the compartment 6 is provided with drive shafts 62, 63 for engagement with driven portions of the tape cartridge 4 mounted in the compartment 6. A feed motor 121 as a drive source drives these drive shafts 62, 63 for rotation to feed or advance the tape T and the ink ribbon R in the tape cartridge C, and at the same time the print head 7 is driven in synchronism with the feeding of the tape and ribbon to carry out printing. Further, after completion of the printing operation, the tape T continues to be fed to bring a predetermined cutting position (corresponding to the tape length) on the tape T to the position of the tape cutter 132.

It should be noted that there is arranged a head surface temperature sensor 144, such as a thermistor, in intimate contact with the surface of the print head 7, for detecting the temperature of the surface of the print head 7 (head surface temperature) and supplying a signal indicative of the detected head surface temperature to the control block 200. Further, the feed motor 121 has an end on which is rigidly fitted a disc, not shown, formed with detection openings, and a rotational speed sensor 141 comprised of a photo sensor or the like is provided to face the path of the detection openings of the disc, for sending information of the rotational speed of the feed motor 121 detected thereby to the control block 200.

The cutter block 13 includes a tape cutter 132, a cutting button 133 for being manually operated to cause the tape cutter 132 to cut the tape T when a desired length printing is carried out, for instance, and a cutter motor 131 for automatically driving the tape cutter 132 to cut the tape T when a fixed length printing is carried out, for instance. To selectively carry out one of the two cutting operations, the tape printing apparatus 1 is capable of being switched between a manual cutting mode and an automatic cutting mode by a mode-setting operation. More specifically, in the manual cutting mode, when the printing operation is completed, the user pushes the cutting button 133 arranged on the casing 2, whereby the tape cutter 132 is actuated to cut the tape T to a desired length. On the other hand, in the automatic cutting mode, after completion of the printing operation, the tape T is sent further by the length of a rear margin, and then stopped, whereupon the cutter motor 131 is driven to cut off the tape T.

The sensor block 14 includes the rotational speed sensor 141, the tape-discriminating sensor 142, the ambient temperature sensor 143, the head surface temperature sensor 144. It should be noted that the above sensors can be omitted to suit the actual requirements of the tape printing apparatus.

The driving block 270 includes a display driver 271, a head driver 272, and a motor driver 273. The display driver 271 drives the display 4 of the operating block 11 in response to control signals delivered from the control block 200, i.e. in accordance with commands carried by the signals. Similarly, the head driver 272 drives the print head 7 of the printer block 12 in accordance with commands from the control block 200. Further, the motor driver 273 includes a feed motor driver 273d for driving the feed motor 121 of the printer block 12, and a cutter motor driver 273c for driving the cutter motor 131 of the cutter block 13, and similarly to the display driver 271 and the head driver 272, drives each motor in accordance with commands from the control block 200.

The operating block 11 includes the keyboard 3 and the display 4. The display 4 has a small-sized horizontally-long display screen 45 which is capable of displaying desired letters, symbols, numerals, figures, etc. in several horizontal lines having the maximum horizontal length corresponding to a predetermined number of letters (characters). The display 4 is used by the user when he enters data via the keyboard 3 to form or edit print image data, such as character string image data, and check the result of the entry, or enters instructions or commands via the keyboard 3.

On the keyboard 3, there are arranged a character key group 31 including an alphabet key group, a number key group, and a nonstandard character key group for calling nonstandard characters for selection, as well as a function key group 32 for designating various operation modes and the like. In a type of apparatus which is capable of entering the Japanese language, the character key group 31 includes a kana key group for entering Japanese hiragana letters and Japanese katakana letters, as well.

The function key group 32 includes a power key 321, a communication key 322 for communication with an external device (for receiving data therefrom), a print key 323 for instructing a printing operation, as well as a selection key for finally determining entry of data, starting a new line, and selecting an option from various menus e.g. of mode selection, an ornamental configuration key for setting the format of an ornament, such as a character ornament and a background pattern, including halftone dot-meshing, underline, and enclosing, a color setting key for setting a character color, a background color, an ornamental color, etc., and cursor keys (up arrow key, down arrow key, left arrow key, and right arrow key) for moving a cursor K or scrolling the range of display on the display screen 45 in respective upward, downward, leftward and rightward directions.

The function key group 32 further includes a cancel key for canceling various instructions, a shift key for changing the roll of each key, modifying registered image data, etc., an image key for switching between a text entry screen or selection screen and an image display screen (image screen) displaying print image data, a proportion changing key (zoom key) for changing the ratio between a size of print image data and a size of display image data displayed on the image screen, and a form key for setting various forms including typefaces of characters.

Of course, similarly to keyboards of the general type, the above-mentioned key entries may be made by the respective keys exclusively provided therefor or by a smaller number of keys operated in combination with the shift key and/or the like. For the ease of understanding, it is assumed here that there are as many keys as mentioned above. As shown in FIG. 3, by using the keyboard 3, various commands and data are input to the control block 200.

The control block 200 includes a CPU 210, a ROM 220, a character generator ROM (CG-ROM) 230, a RAM 240, a peripheral control circuit (P-CON) 250, all of which are connected to each other by an internal bus 260. The ROM 220 has a control program area 221 for storing control programs executed by the CPU 210 as well as a control data area 222 for storing control data including a color conversion table, and a character modification table. The CG-ROM 230 stores bit map data, i.e. data defining symbols, figures and the like, provided for the tape printing apparatus 1. When code data for identifying a character or the like is input thereto, it outputs the corresponding bit map data.

The RAM 240 is supplied with power by a backup circuit, not shown, such that stored data can be preserved even after the power is turned off by operating the power key 321. The RAM 240 includes areas of a register group 241, a character data area 242 for storing character data of letters or the like input by the user via the keyboard 3, a display image data area 243 for storing image data displayed on the display screen 45, a print image data area 244 for storing print image data, a registered image data area 245 for storing registered image data, as well as a print record data area 246 and conversion buffer areas 247 including a color conversion buffer. The RAM 240 is used as a work area for carrying out the control process.

The P-CON 250 incorporates logic circuits for complementing the functions of the CPU 210 as well as dealing with interface signals for interfacing between the CPU 210 and peripheral circuits. The logic circuits are implemented by gate arrays, a custom LSI and the like. For instance, a timer 251 is also incorporated in the P-CON 250 for the function of measuring elapsed time. To perform its functions, the P-CON 250 is connected to the sensors of the sensor block 14 and the keyboard 3, for receiving the above-mentioned signals generated by the sensor block 14 as well as commands and data input via the keyboard 3, and inputting these to the internal bus 260 directly or after processing them. Further, the P-CON 250 cooperates with the CPU 210 to output data and control signals input to the internal bus 260 by the CPU 210 or the like, to the driving block 270 directly or after processing them.

The CPU 210 of the control block 200 receives the signals from the sensor block 14, and the commands and data input via the keyboard 3 via the P-CON 250, according to the control program read from the ROM 220, processes bit map data from the CG-ROM 230 and various data stored in the RAM 240, and delivers control signals to the driving block 270 via the P-CON 250 to thereby carry out position control during printing operations, display control of the display screen 45, and printing control of the print head 7 to carry out printing on the tape T under predetermined printing conditions. In short, the CPU 210 controls the overall operation of the tape printing apparatus 1.

The tape printing apparatus 1 is capable of printing data stored in an external apparatus, such as an electronic learning machine S and a personal computer (PC), on the tape T by connecting the main unit 2 and the external apparatus. As shown in FIG. 4, the tape printing apparatus 1 and the electronic learning machine S are placed in a communicative connection wait state by connecting between the main unit 2 and the PC by the cable, and the communicative connection wait state is switched to a communicative connection-enabled state by turning on the communication key 322.

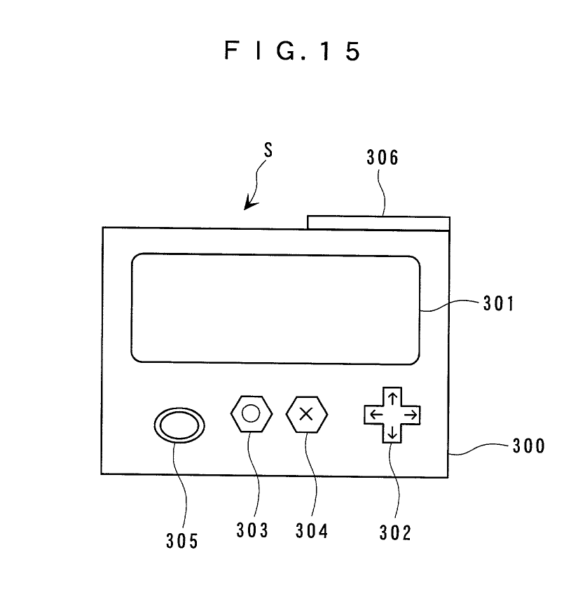

As shown in FIG. 15, the electronic learning machine S is a general small-sized electronic apparatus used by junior or senior high-school students as learning aid, and has an apparatus body 300, a display 301 arranged on the apparatus body 300 for displaying questions, answers to the questions, etc., a cursor key 302 for selecting one from alternatives, a nought key 303 for being depressed when the student judges that an answer to a question is correct, a cross key 303 for being depressed when the student judges that an answer to a question is wrong, a power key 305 for turning on and off the power, and a storage medium-mounting block where a storage medium 310 storing various learning data is mounted. The storage medium 310 stores learning data classified into subjects and units of each subject, and the electronic learning machine S is capable of changing between a plurality of storage mediums 310 for allowing the student to learn various subjects and units. The electronic learning machine S may be configured to incorporate a storage section storing learning data.

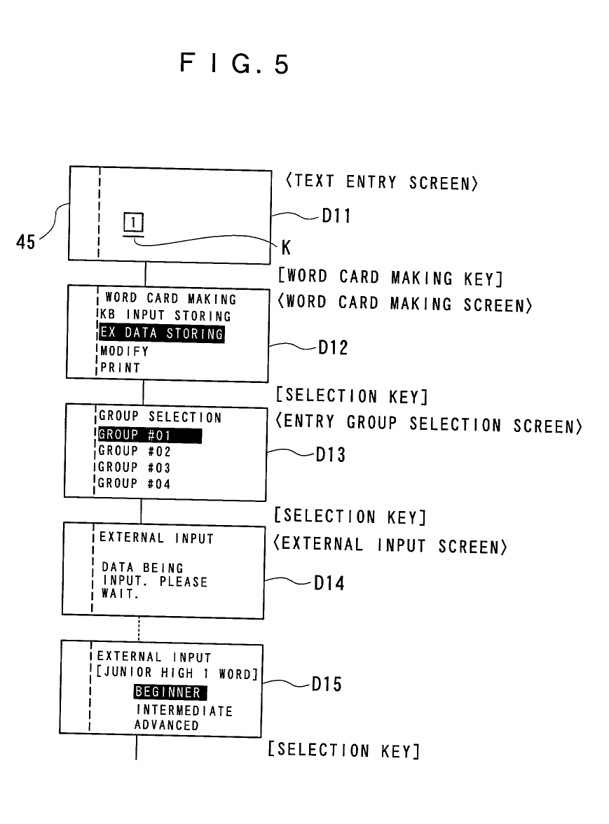

Now, the printing method using the tape printing apparatus 1 will be described. The tape printing apparatus 1 according to the invention is capable of printing based on data stored in a manner correlated with each other, as in the case of a question and an answer thereto, in a predetermined format enabling visual recognition of the relevancy between the question and the answer, by a simple and easy operation of the student. Details of the printing method will be described while referring to images displayed on the screen 45 illustrated in FIGS. 5 to 10. It is assumed here that the tape printing apparatus 1 is in a state connected to the electronic learning machine 1 as shown in FIG. 4, and a storage medium 310 for learning English words is mounted in the electronic learning machine S. Further, it is also assumed that the electronic learning machine S has already been turned on.

As shown in FIG. 5, when the power is turned on, first, there is shown an text entry screen (D11). In the text entry screen, there are displayed a boxed numeral 1 (1 in a box) indicating that entry of characters is to be made on a first line, and a cursor K. In this screen D11, the cursor K is attached to the boxed numeral 1, and hence a character inputted next is displayed on a right-hand side of the boxed numeral 1.

Now, if the user depresses a “word card-making key”, the screen switches to a word card-making screen (D12). In this screen, there are displayed “WORD CARD MAKING” showing that the present screen is displayed due to depression of the word card-making key, as well as options of “KB INPUT STORING” (“keyboard input storing”), “EX DATA STORING” (“external data storing”), “MODIFY”, and “PRINT”. Of these options, “EX DATA STORING” is highlighted by default as an option selected most recently. To select the default option, the user depresses the selection key in the illustrated state (in the highlighted state of the option).

To select another option, the user depresses the cursor key or the like. In response to this operation, options are sequentially displayed in halftone dot meshing, and an option displayed in halftone dot meshing is selected when the user depresses the selection key (the processing is carried out according to the selected option). The selection of menu options is carried out by similar operations, and hence hereafter detailed description of such operations is omitted, but simply described as “an option is selected, or the selection key is depressed”. In the illustrated example, the EX DATA STORING (external data storing) is selected, and therefore, the selection key is depressed in the illustrated state.

In the word card making screen (D12), in addition to the options displayed on the screen 45, i.e. “KB INPUT STORING” for inputting and storing data by operation of the keyboard, “EX DATA STORING” for inputting and storing data by connection to the electronic learning machine by communication, “MODIFY” for modifying stored data, and “PRINT” for printing data, it is also possible to select “DELETE” for deleting stored data, and “COPY” for copying data to another group. Out of these options, “KB INPUT STORING”, “EX DATA STORING”, and “PRINT” will be described in detail hereinafter.

In the word card making screen (D12), when the “EX DATA STORING” is selected, the screen is switched to an entry group selection screen (D13). In this screen, there are displayed “GROUP SELECTION” indicating that the present screen is for selecting a group into which input data are to be stored, and options of groups which can be newly stored as entries to word card data. In the illustrated example, since no group has been stored, “GROUP #01” is highlighted by default.

It should be noted that data may be stored not in “GROUP #01”, but in “GROUP #02”, “GROUP #03” or another. The once stored group number is not displayed. Further, the number of groups that can be stored has a limit of 20. In the present state, however, only GROUP #01 to GROUP #04 are displayed, and as the cursor key is depressed, a group having a larger group number is displayed. In the illustrated example, “GROUP #01” is selected as entry group into which data are to be stored.

When the group in which data are to be stored as entries has been selected, the screen is switched to an external input screen (D14) for receiving data from an external apparatus (electronic learning machine S in the present case). In the external input screen, there are displayed “EXTERNAL INPUT indicating that data are inputted from an external apparatus as well as a message notifying that external data are being inputted. In a few seconds, the reception or external input of the data is completed, and contents of the data are displayed on the screen (D15).

The inputted data are received from the storage medium 310 mounted in the electronic learning machine S, and on the external input screen, there are displayed [JUNIOR HIGH 1 WORD] representing Junior High school, 1st Grade, English Words, and three courses thereunder, i.e. “BEGINNER”, “INTERMEDIATE”, and “ADVANCED”, as options for selection. In the illustrated example, it is assumed that “BEGINNER” is selected, and hence the user depresses the selection key in the state of “BEGINNER” being highlighted by default.

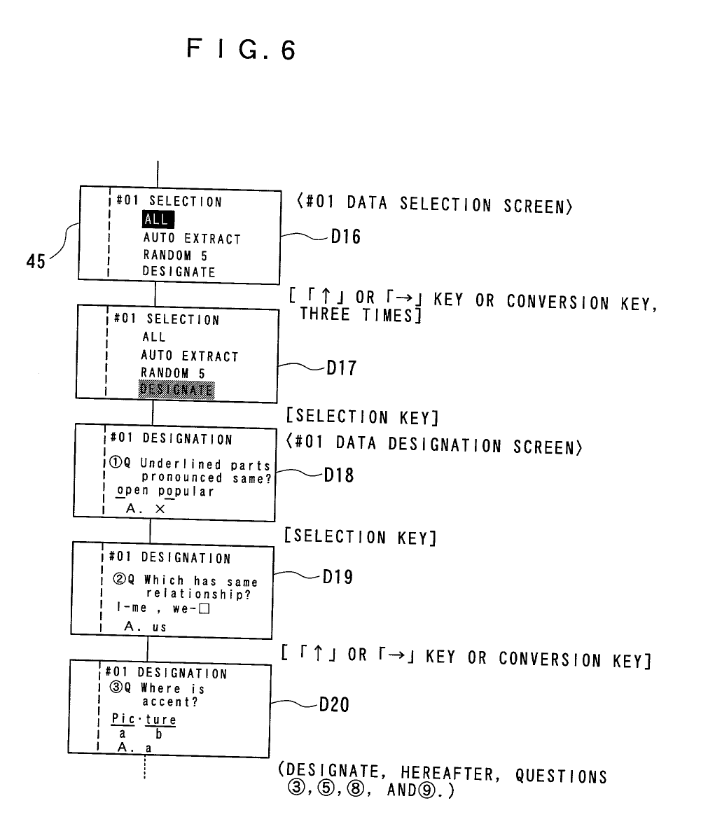

When the data to be inputted is selected, as shown in FIG. 6, the screen is switched to #01 data selection screen (D16). In this screen, there are displayed “#01 SELECTION” showing that this screen is for selecting data to be stored as entries in “GROUP #01”, as well as the options of “ALL” for selecting all data under the present option (in the illustrated example, all data of “BEGINNER”), “AUTO EXTRACT” for selecting data (shown in a screen hierarchically immediately under this option) by a predetermined rule (in the illustrated example, “questions concerning growth of children”, “questions to which wrong answers have been made during learning using the electronic learning machine”, etc.), “RANDOM 5” (for randomly selecting five data irrespective of the contents of questions, and “DESIGNATE” for selecting designated data (shown in a screen hierarchically immediately under this option).

When “AUTO EXTRACT” is selected, the screen is switched to the screen under the hierarchically lower level, and data to be stored or are selected by designating one of the predetermined rules. When “DESIGNATE” is selected as well, the screen is switched to the screen under the hierarchically lower level, and data to be stored are designated thereat. Further, when “ALL” or “RANDOM 5” is selected, data to be selected are fully specified at this time point, and hence the entry data storing process is terminated. In the illustrated example, it is assumed that “DESIGNATE” is selected, and hence the user depresses the right arrow key, the up arrow key or a conversion key (hereinafter simply and collectively referred to as “the cursor key”), three times, from the screen D16 and the selection key is depressed in the state of the “DESIGNATION” being displayed in halftone dot meshing.

In the #01 data selection screen, when “DESIGNATE” is selected, the screen is switched to #01 data designation screen (D18). In the #01 data designation screen (D18), there are displayed “#01 DESIGNATION” showing that the present screen is for designating data to be stored in the GROUP #01, as well as data to be designated (question data and answer data). The data displayed may be either the question data or the answer data.

Data are sequentially displayed from circled number 1 (hereinafter referred to as circled 1, and the same applies to other circled numbers) in an increasing order, and when the user wishes to register the displayed data, the selection key is depressed in the state of the data being displayed. For instance, in the screen (D18), Question circled 1 is displayed, when the user depressed the selection key in this state, the data of Question circled 1 is designated to be stored as an entry. Then, Question circled 2 is displayed on the screen (D19). In the illustrated example, the selection key is not depressed, and hence Question circled 2 is not designated. In the present case, the cursor key is depressed to display Question circled 3 (D20). Thus, by depressing the selection key and the cursor key, designation of storing of Questions circled 3, 5, 8, and 9 as entries is carried out thereafter. As a result, designation of storing of five data of Questions circled 1, 3, 5, 8, and 9 as entries is effected in the illustrated example.

It should be noted that the designation of the questions may be carried out not by depression of the selection key in a state of a question or an answer being displayed, as described above, but by directly entering the number of each question (e.g. while referring to numbers jotted down as a note during learning using the electronic learning machine) by using number keys. This configuration of the data designation process makes it possible to designate data promptly.

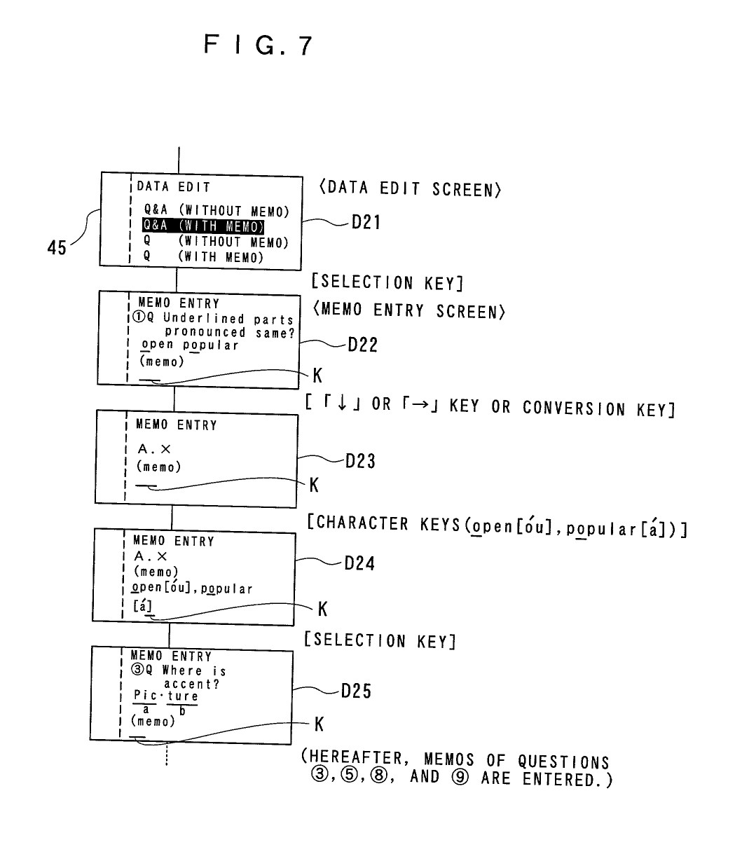

When the designation of data to be stored is completed, the screen is switched to a data edit screen (D21), as shown in FIG. 7. In the data edit screen, there are displayed “DATA EDIT” showing that the present screen is for editing data, and the options of Q&A (WITHOUT MEMO), Q&A (WITH MEMO), Q (WITHOUT MEMO), and Q(WITH MEMO), with the option Q&A (WITH MEMO) being highlighted. Although not displayed at this stage, there are also the other options of A(WITHOUT MEMO), and A(WITH MEMO) for selection. “Q&A” represents that question data (Q) and =answer data (A) are both to be stored, “Q” that only question data (Q) are to be stored, and “A” that only answer data (A) are to be stored. Further “WITH MEMO” and “WITHOUT MEMO” show that the question data (Q) or answer data (A) are to be stored together with a memo. In the illustrated example, “Q&A (WITH MEMO)” is selected. It should be noted here that when the option with “WITHOUT MEMO” is selected, the entry data storing process is terminated at this point.

Then, the screen is switched to a memo entry screen (D22). In the memo entry screen, there are displayed “MEMO ENTRY” showing that the present screen is for entry of memos, and question data of Question circled 1 is displayed. Entry of a memo is carried out by using the keyboard 3, and the first letters entered are displayed at a location indicated by the cursor K. In the illustrated example, no entry of a memo is effected, but the cursor key is depressed to cause the screen to be switched to a screen (D23) displaying answer data of Question circled 1. In this screen, the memo of “open[ou], popular[a]” is entered (D24), and the depression key is depressed, so that the screen is switched to a screen (D24) displaying Question circled 3 to be entered next. The memos of data circled 3, 5, 8 and 9 are entered.

The storing of the designated data is effected when the entry of (memo) to be added to the last data of answer data of Question circled 9 is completed (at the time of depression of the selection key in the memo entry screen for entering the answer data of Question circled 9), whereby the data are stored in the storage device (RAM 240) within the tape printing apparatus 1.

By the above operations, the data are stored in “GROUP #01”. To simplify the operations, the entry data storing process may be configured such that editing of data or entry of memos is not carried out. Further, the same process may be configured such that question data and answer data can be rewritten.

Further, in this case, the process may be configured such that part or all of question data and answer data can be replaced by blank data. According to this configuration, the form of answers and questions can be diversified e.g. by replacing part of question data by blanks and causing letters and symbols to be entered thereto serve as contents of answer data.

Further, the entry data storing process may be also configured such that by depressing the print key 323 at a desired stage of the entry data storing process described heretofore, data to be stored as entries can be subjected to printing. For instance, in the external data entry screen (D15) in FIG. 5, at the time of election of an option (“BEGINNER” in the illustrated example), by depressing the print key 323, the designated data of Question data and Answer data (in the illustrate examples, data of Questions and Answers circled 1, 3, 5, 8, and 9) may be printed. According to this configuration, since the data are not stored, there is no fear of decrease of the capacity of the storage medium, and further the printing operation can be simplified. In the following, description will be given of a method of printing data which are designated to be stored as entries by the above entry data storing process and once stored in the storage device 240.

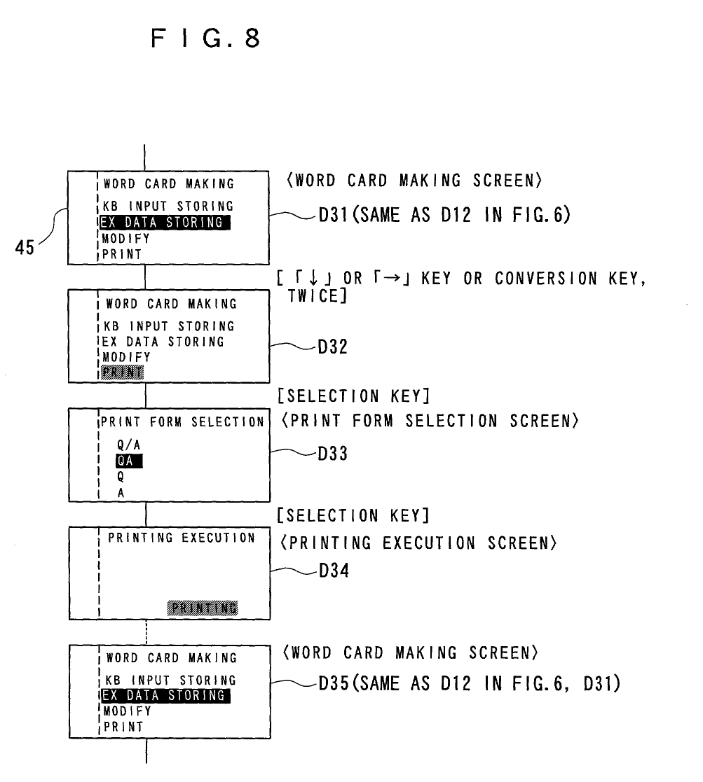

Referring to FIG. 8, in the word card making screen, when the option of “EX DATA STORING” selected by default (D31: same as D12 in FIG. 5) is in the highlighted state, if the user depresses the cursor key twice, the option “PRINT” is displayed in halftone dot meshing (D32), and when the selection key is depressed, the screen is switched to a print form selection screen (D33). In the print form selection screen, there are displayed “PRNT FORM SELECTION” showing that the present screen is for selecting a print form, and the options of “Q/A” (printing Q (question data) and A (answer data) in a separate state), “QA” (printing Q and A in a joined state) “Q” (printing Q alone), and “A” (printing A alone). In the illustrated example, in the state of the “QA” selected by default and hence highlighted, the user depresses the selection key, whereby the screen is switched to a printing execution screen (D34).

In the print execution screen, there are displayed not only “PRINTING EXECUTION” showing that execution of the printing has been instructed, but also “PRINTING” in halftone dot meshing showing that the printing is being carried. The printing is finished in a few seconds, and then the tape is cut at a proper location, whereby a label (printed strip of the tape T) is produced which is printed with answer data and question data in a state entered side by side in a horizontal direction, as shown in FIG. 11A. When the printing is completed, the screen 45 returns (is switched) to the word card making screen (D35: same as D12 in FIG. 5 and D31 in FIG. 8).

The printed strip of the tape T thus prepared (hereinafter simply referred to as “the tape string T”) has its peel layer Tc on the reverse side peeled off, and is bent at a central position (along a line shown in dots), and is affixed to an object article (word card in the present case) N such that the bent tape sandwiches the object article N. Then, as shown in FIG. 11C, by filing a plurality of numbers of word cards having respective tape strips T affixed thereto, an original vocabulary-building words collection can be made.

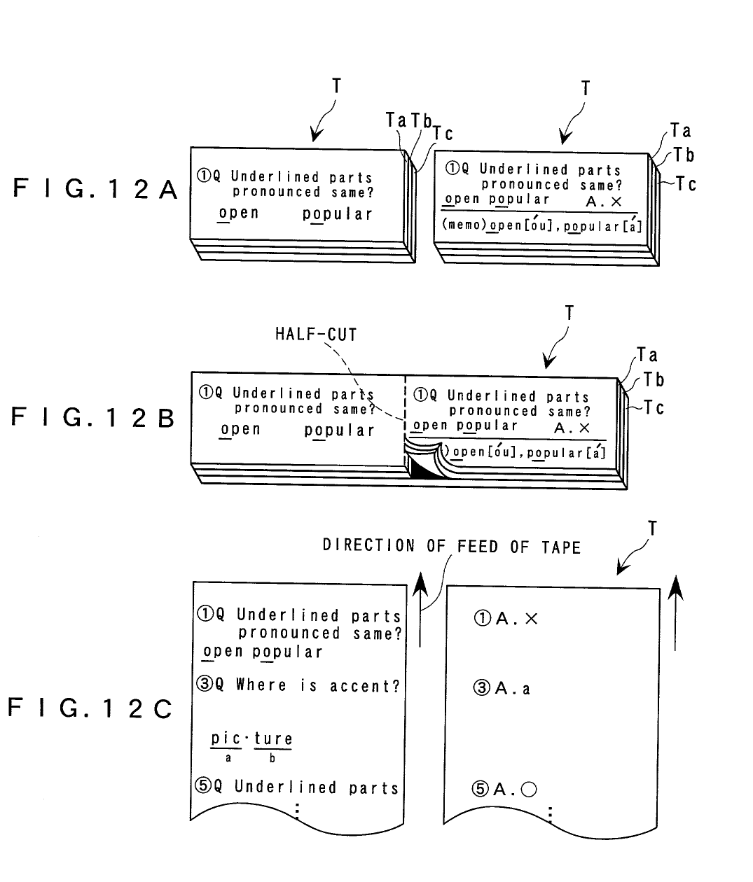

It should be noted that in the print form selection screen (D33 in FIG. 8), when “Q/A” is selected, as shown in FIG. 12A, the tape T is cut off to form question and answer portions as respective separate strips. In this case, the question portion and the answer portion can be affixed to the top side and the reverse side of the word card separately, to thereby form a word card similarly to the above. However, since the question portion and the answer portion are separately formed, they may affixed to a notebook to form a vocabulary-building wordbook.

Further as shown in FIG. 12B, even in the separately printed question portion and answer portion, the boundary may not be cut through but may be subjected to half-cutting (in which only the image-receiving layer Ta and the adhesive layer Tb are cut). According to this configuration, when a plurality of data are printed, it is possible to prevent question portions and answer portions from becoming apart and mistaken as another.

Further, although in the above embodiment, the text entry screen is changed over to the word card making screen, this is not limitative, but the screen may be switched from the text entry screen to a screen for selection of a format of a label (options of “WORD CARD MAKING”, “NOTEBOOK LABEL”, etc. are displayed), and then to a label forming screen under the selected option. In addition to the word card making key, there may be provided a notebook label making key. According to this configuration, it is possible to form not only labels for being affixed to word cards but also labels in various formats.

In this case, the present apparatus is preferably configured such that labels with the question portions and the answer portions printed separately as shown in FIG. 12C can be made. According to this configuration, these labels can be affixed to an object article such that it can be made use of as an original collection of questions.

Further, in this case, it is preferred that the printing is carried out such that the direction of extension of lines is crosswise to that of feed of the tape T. According to this configuration, there is no limit in the number of lines, so that the number of letters for each question or that of letters of each answer can be freely increased.

Further, in this case, it is preferred that a question and an answer to the question are printed on respective lines having an identical line number. According to this configuration, when the tape strip T of the question portion and the tape strip T of the answer portion are affixed to the object article N, such as a notebook, side by side, it is easier to check for the answer to the question.

Further, in this case, when printing, numbers assigned to respective questions and answers may be configured not to be circled 1, 3, 5, . . . , but numbers 1, 2, 3, . . . sequentially assigned to the printed questions and answers (in the illustrated example, the original question numbers (circled numbers) are printed as they are). According to such a configuration, it is possible to form a collection of problems which does not give an odd impression (without missing numbers).

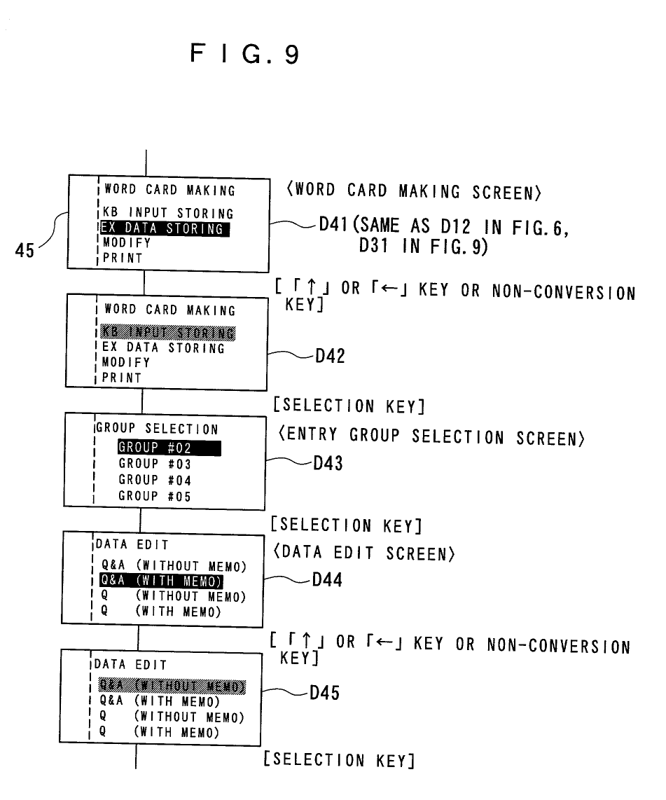

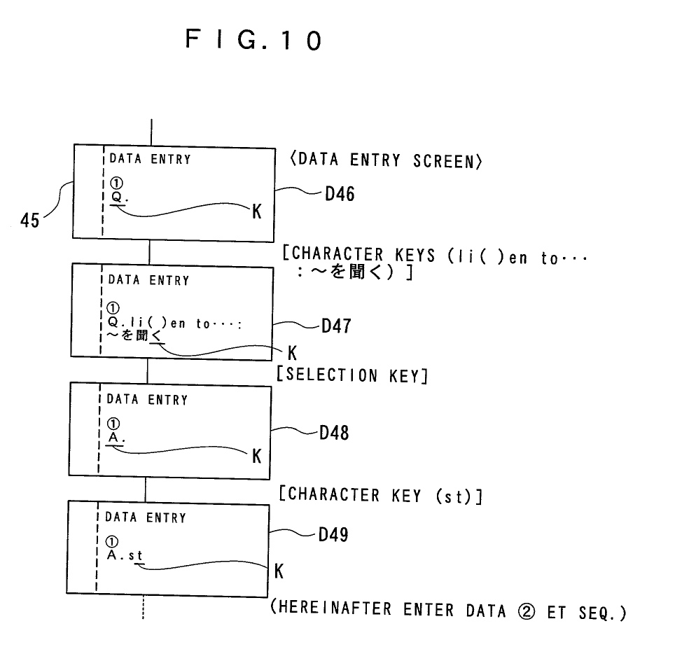

Next, the method of storing data inputted by the keyboard 3 as entries to the word card data will be described according to an operating procedure with reference to FIGS. 9 and 10. First, in the word making screen, in the state of the “EX DATA STORING” selected by default and hence highlighted (D41; same as D12 in FIG. 5, D31 in FIG. 8, and so forth), when the user depresses the cursor key, “KB INPUT STORING” is displayed in halftone dot meshing (D42), and when the selection key is depressed in this state, the screen is switched to an entry group selection screen” (D43).

In the entry group selection screen, there are displayed “GROUP SELECTION” showing that the present screen is for selection of a group in which data should be stored as entries, and the options of “GROUP #02”, “GROUP #03”, “GROUP #04”, and “GROUP #05”. In this screen, since “GROUP #01” has been already stored as an entry, the option “GROUP #01” is not displayed.

In the present sequence of operations, to store data in “GROUP #02” as entries, the selection key is depressed in the state of the option “GROUP #02” being selected by default and hence highlighted, so that the screen is switched to the data edit screen (D44). In the data edit screen, the same options as displayed in the data edit screen D21 in FIG. 7 are displayed. In the illustrated example, to print question data (Q) and answer data (A) without entry of a memo, the user depresses the cursor key, and in the state of the option “Q&A(WITHOUT MEMO” being displayed in halftone dot meshing (D45), the selection key is depressed.

When the option is selected in the data edit screen, the screen is switched to a data entry screen (D46) as shown in FIG. 10. In the data entry screen, there are displayed circled 1 indicative of the number of data (Question and Answer), and the cursor K is located at “Q” which shows that data to be entered here is question data. When the characters “lio( )en to . . . : [symbol] ” are entered, these characters are displayed on the screen (D47), and then when the selection key is depressed, a screen (D48) appears in which the cursor K is located at “A” which shows that data to be entered here is answer data. In this state, characters (st) are entered as answer data.

Similarly to the above, data of circled 2, et seq. are entered. It should be noted that in the data edit screen (D45 in FIG. 9), when an option with (WITH MEMO) is selected, the user is prompted to enter a memo after entry of each pair of question data and answer data.

Further, in the present case as well, the apparatus may be configured such that by depressing the print key 323 at a desired stage of the above data entry procedure, data to be stored are entries can be printed. It should be noted that an operation of printing after entry data storing is the same as described hereinabove with reference to FIG. 8, and hence description thereof is omitted.

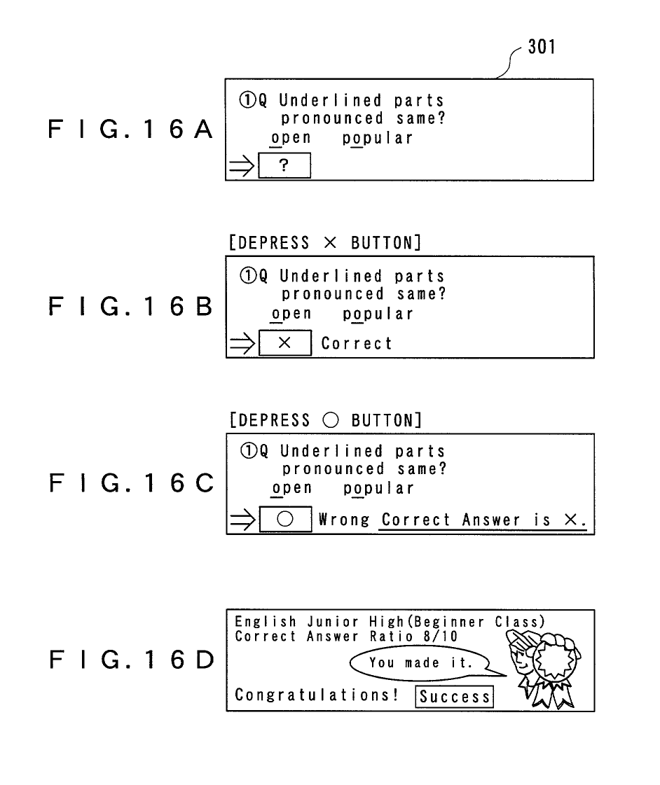

Next, the process of printing results of learning will be briefly described. In the electronic learning machine S, when a predetermined number of questions are answered, results of learning, such as a correct answer ratio and a test score, are displayed. In the state of this screen is displayed, by connecting the electronic learning machine S to the cable 33 by using the cable 33, and then depressing the print key 323, the displayed screen as shown in FIG. 16D is printed as it is (copying of the screen is carried out). Thus, by printing results of learning displayed on the machine S temporarily, the user can grasp the stage of progress of his/her learning and also experience a sense of mastery.

Further, if a different image giving a certificate of achievement appears for display and printing whenever a different unit of a subject is mastered, a user can be motivated to learning by the concrete and attractive goal of collecting items of such printed images. It should be noted that when the electronic learning machine S is not equipped with the function of displaying such an image, data indicative of results of learning can be taken in from the electronic learning machine S, and then the data are converted to an image corresponding to the results of learning, for printing.

As described above, according to the printing apparatus and method of the present invention, based on data stored in a correlated manner as in the case of questions (problems) and respective answers thereto, which are used in an electronic learning machine, it is possible to print the questions and answers in a format enabling affixation to word cards and the like, without going through a complicated configuration process. Further, the stored data can be read from an external apparatus (electronic learning machine or the like), and hence it is possible to print a wide variety of question data and/or answer data.

It should be noted that when learning is carried out by the electronic learning machine, data indicative of whether each question is answered correctly or not may be stored, thereby allowing only questions which cannot be answered correctly to be extracted for printing. According to this configuration, it is possible to make an original collection of vocabulary-building word cards or of problems which is suited to a learning stage of the user (since questions and problems with which the user has had difficulty are extracted).

In this case, in the state of the electronic learning machine S and the tape printing apparatus 1 being connected to each other, only questions which cannot be answered correctly may be automatically subjected to printing as the user proceeds with a unit of learning. According to this configuration, when the unit of learning is completed, the printing can be also completed. That is, word cards or a collection of problems can be made swiftly.

Further, the tape printing apparatus 1 may be configured to have only the function of printing, but not have the functions of edit and cutting, the display screen or the keyboard. In this case, processing which requires an editing capability and a display screen, such as selection and designation of data to be printed, and preparation of print image data, may be left to the electronic learning machine S.

According to this configuration, the tape printing apparatus need not have the functions of edit and display, and hence it can be simplified in construction, and reduced in its size.

If the construction of the apparatus is simplified as above, when the electronic learning machine S is connected to the apparatus after learning by using the same, only answers which were not answered correctly may be automatically subjected to printing (only by turning on the power of the printing apparatus). According to this configuration, the questions and answers can be printed quickly in a simplified fashion to make an original collection of vocabulary-building word cards or a collection of problems.

Further, a collection of main points in which main points or notes of problems are collected or a map in which names of places and special goods produced in respective places are entered may be stored in the electronic learning machine (or a storage medium 310 storing them may be mounted), for printing.

Further, the printing apparatus and method may be configured such that it is possible to print labels printed with information displayed on the display screen of the electronic learning machine S, such as “Index Labels” which can be conveniently used for making vocabulary-building word cards, labels printed with “Important!” and “POINT” which can be conveniently used for arranging or organizing contents jotted down on the notebook, “Time Label” for certifying learning hours of the user, etc.

Although in the example described above, in the data edit screen (D21 in FIG. 7, D44 in FIG. 9, and the like), the printing apparatus is configured to be capable of selecting data to be printed, and select between data with a memo and data without a memo, this is not limitative, but there may be provided other options of editing, including an option of selecting a print form, and an option of selecting a font (typeface) of characters. According to this configuration, it is possible to prepare a wide variety of labels.

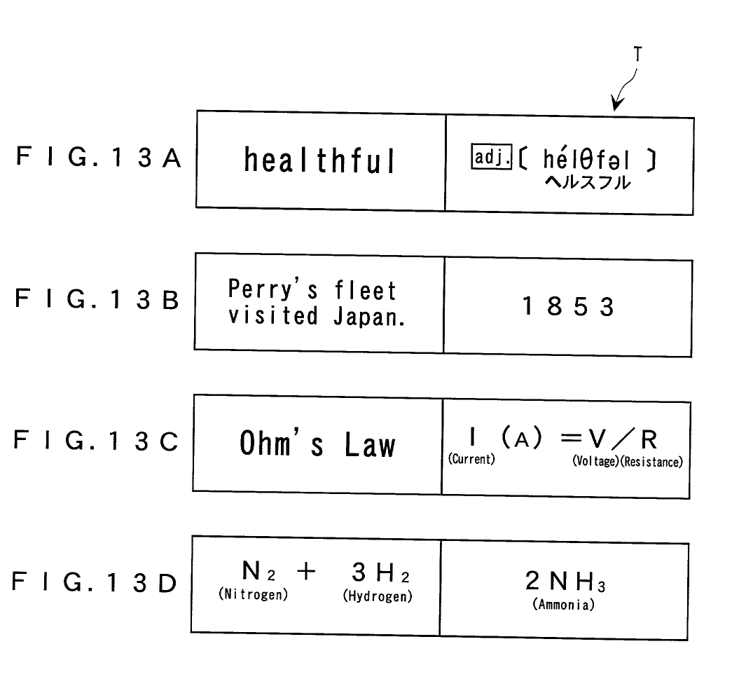

Further, the above embodiment has been given while referring to question data and answer data concerning English words, as an example of data correlated with each other, this is not limitative, but as shown in FIG. 13A, the printing apparatus may be configured to be capable of printing English words, phonetic symbols, and positions of accent, in a fashion enabling visual recognition of the relevancy therebetween.

As shown in FIG. 13B, the printing apparatus may be configured to be capable of printing events in history, and years in which respective events occurred, in a fashion enabling visual recognition of the relevancy therebetween.

Also, as shown in FIG. 13C, the printing apparatus may be configured to be capable of printing the name of a natural law and a mathematical expression or meaning of the law in a format enabling visual recognition of the relevancy therebetween.

Further as shown in FIG. 13D, the printing apparatus may be configured to be capable of printing a chemical reaction formula and a substance or substances produced by the chemical reaction, in a format enabling visual recognition of the relevancy therebetween.

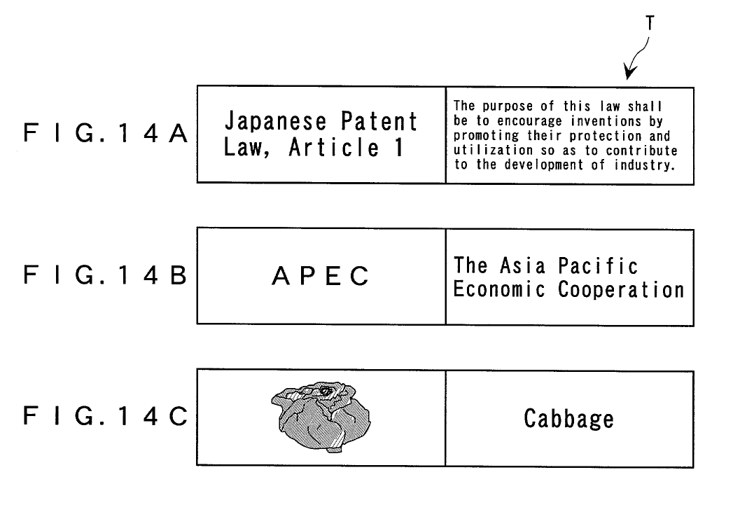

Also as shown in FIG. 14A, the printing apparatus may be configured to be capable of printing a name of a provision of a law and contents of the provision, in a format enabling visual recognition of the relevancy therebetween.

Also as shown in FIG. 14B, the printing apparatus may be configured to be capable of printing an abbreviated name and a full description corresponding thereto, in a format enabling visual recognition of the relevancy therebetween.

Also as shown in FIG. 14C, the printing apparatus may be configured to be capable of printing not only characters, but also an image or pattern and characters or symbols representative of the image or pattern, in a format enabling visual recognition of the relevancy therebetween.

In the embodiment described above, as the example of the external apparatus storing data (question data and answer data), the electronic learning machine S has been described, the printing apparatus of the present invention is not limited to this, but it can be applied to lots of other electronic devices and apparatuses using character information, such as electronic dictionaries, and personal computers. Further, it goes without saying that the method of the present invention is not limitatively applied to the tape printing apparatus 1, but can be applied to other electronic devices and apparatuses, such as printers.

It is further understood by those skilled in the art that the foregoing is a preferred embodiment of the invention, and that various changes and modifications may be made without departing from the spirit and scope thereof.

What is claimed is:

1. A printing apparatus comprising:
reading means for reading out stored data including question data and answer data corresponding thereto which are stored in a manner correlated with each other; and
printing means for printing the question data and the answer data on a print medium, based on the stored data read out by said reading means, in a predetermined format enabling visual recognition of relevancy between the question data and the answer data.

2. A printing apparatus according to claim 1, further including print data-forming means for forming print data composed of at least one item of the question data and at least one item of the answer data corresponding thereto, respectively, based on the stored data read out by said reading means, and
wherein said printing means includes means for printing the question data and the answer data based on the print data formed by said print data-forming means.

3. A printing apparatus according to claim 2, wherein said print data-forming means includes means for forming the print data based on designated question data which is arbitrarily selected from the at least one item of the question data and answer data corresponding to the designated question data.

4. A printing apparatus according to claim 2, wherein said print data-forming means includes means for forming the print data based on extracted question data which is extracted from the at least one item of the question data according to a predetermined rule, and answer data corresponding to the designated question data.

5. A printing apparatus according to claim 2, wherein said print data-forming means includes means for forming the print data by replacing part or all of at least one of the question data and the answer data corresponding to the question data by blank data.

6. A printing apparatus according to claim 1, including display means for displaying the question data and the answer data, in a state in which the relevancy between the question data and the answer data corresponding thereto can be visually recognized.

7. A printing apparatus according to claim 6, wherein said display means includes means for displaying the question data and the answer data in at least one of a state in which the question data and the answer data are displayed separately and a state in which the question data and the answer data are displayed simultaneously.

8. A printing apparatus according to claim 1, further including cutting means for cutting the print medium to a desired length, and
wherein said cutting means includes means for cutting the print medium such that a question portion on which printing is carried out based on the question data and an answer portion on which printing is carried out based on answer data corresponding to the question data come apart.

9. A printing apparatus according to claim 1, further including cutting means for cutting the print medium to a desired length, and
wherein said cutting means includes means for cutting the print medium such that a question portion on which printing is carried out based on the question data and an answer portion on which printing is carried out based on answer data corresponding to the question data are in a state remaining connected to each other.

10. A printing apparatus according to claim 1, further including input means capable of inputting at least one of the question data and the answer data.

11. A printing apparatus according to claim 1, further including storage means for storing the stored data, and
wherein said reading means includes means for reading out the stored data stored in said storage means.

12. A printing apparatus according to claim 1, further including external storage device-connecting means for connecting an external storage device storing the stored data to the printing apparatus, and
wherein said reading means includes means for reading out the stored data stored in the external storage device via said external storage device-connecting means.

13. A printing apparatus according to claim 1, further including storage medium-mounting means for mounting a storage medium storing the stored data, and
wherein said reading means includes means for reading out the stored data from said storage medium via said storage medium-mounting means.

14. A printing apparatus according to claim 1, wherein said print medium comprises an image-receiving layer serving as a printing surface, an adhesive layer formed on a reverse side of the image-receiving layer, and a peel layer formed on a side of the adhesive layer opposite to the image-receiving layer, said print medium being affixable to an object article by peeling the image-receiving layer and the adhesive layer from the peel layer.

15. A printing apparatus according to claim 1, wherein said print medium is a tape-shaped member.

16. A printing apparatus according to claim 1, wherein the stored data includes question data and answer data having relevancy between a word of a foreign language and a corresponding word of a user's mother tongue.

17. A printing apparatus according to claim 1, wherein the stored data includes question data and answer data having relevancy between a word of a language and phonetic symbols corresponding thereto.

18. A printing apparatus according to claim 1, wherein the stored data includes question data and answer data having relevancy between a name of a provision of a law and contents of the provision.

19. A printing apparatus according to claim 1, wherein the stored data includes question data and answer data having relevancy between an event in history of a year in which the event occurred.

20. A printing apparatus according to claim 1, wherein the stored data includes at least one of question data represented in an image or pattern and answer data represented in an image or pattern.

21. A printing method comprising the steps of:
reading out stored data including question data and answer data corresponding thereto which are stored in a manner correlated with each other; and
printing the question data and the answer data on a print medium, based on the stored data read out, in a predetermined format enabling visual recognition of relevancy between the question data and the answer data.

22. A printing method according to claim 21, further including the step of forming print data composed of at least one item of the question data and at least one item of the answer data corresponding thereto, respectively, based on the stored data read out, and
wherein the step of printing includes printing the question data and the answer data based on the print data formed in the step of forming print data.

23. A printing method according to claim 22, wherein the step of forming print data includes forming the print data based on designated question data which is arbitrarily selected from the at least one item of the question data and answer data corresponding to the designated question data.

24. A printing method according to claim 22, wherein the step of forming print data includes forming the print data based on extracted question data which is extracted from the at least one item of the question data according to a predetermined rule, and answer data corresponding to the designated question data.

25. A printing method according to claim 22, wherein the step of forming print data includes forming the print data by replacing part or all of at least one of the question data and the answer data corresponding to the question data by blank data.
